(19) United States
(12) Patent Application Publication
(10) Pub. No.: US 2025/0089061 A1
(43) Pub. Date: Mar. 13, 2025

(54) TERMINAL, RADIO COMMUNICATION METHOD, AND BASE STATION

(71) Applicant: NTT DOCOMO, INC., Tokyo (JP)

(72) Inventors: Haruhi Echigo, Tokyo (JP); Hiroki Harada, Tokyo (JP); Yuki Matsumura, Tokyo (JP); Naoya Shibaike, Tokyo (JP); Satoshi Nagata, Tokyo (JP)

(73) Assignee: NTT DOCOMO, INC., Tokyo (JP)

(21) Appl. No.: 18/294,012

(22) PCT Filed: Aug. 5, 2021
(86) PCT No.: PCT/JP2021/029215

§ 371 Date: Jan. 31, 2024

(51) Int. Cl. H04W 72/231; H04L 1/1812; H04L 1/1829

(52) U.S. Cl. CPC H04W 72/231; H04L 1/1812; H04L 1/1854

(57) ABSTRACT

A terminal according to one aspect of the present disclosure includes a receiving section that receives a Medium Access Control control element (MAC Control Element (CE)) including a field indicating a time period from a given timing until activation of a transmission configuration indication state (TCI state), and a control section that controls the activation of the TCI state based on the MAC CE. According to one aspect of the present disclosure, it is possible to implement suitable maintenance of communication quality.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication technologies, it is studied that artificial intelligence (AI) technologies, such as machine learning (ML), are utilized for control and management of a network/device and the like. For example, AI-aided beam management using AI-aided estimation is under study.

However, studies of concrete details of the AI-aided beam management have not yet been advanced. Unless these are defined appropriately, improvement in communication throughput or communication quality may be suppressed.

Thus, an object of the present disclosure is to provide a terminal, a radio communication method, and a base station that can implement suitable maintenance of communication quality.

### Solution to Problem

A terminal according to one aspect of the present disclosure includes a receiving section that receives a Medium Access Control control element (MAC Control Element (CE)) including a field indicating a time period from a given timing until activation of a transmission configuration indication state (TCI state), and a control section that controls the activation of the TCI state based on the MAC CE.

### Advantageous Effects of Invention

According to one aspect of the present disclosure, it is possible to implement suitable maintenance of communication quality.

### BRIEF DESCRIPTION OF DRAWINGS

FIG. 1 is a diagram to illustrate an example of a beam pattern indication.

FIG. 2 is a diagram to illustrate an example of control based on a beam pattern indication.

FIG. 3 is a diagram to illustrate an example of an application timing of a predicted PUCCH spatial relation indication including one time offset.

FIG. 4 is a diagram to illustrate an example of an application timing of a predicted PUCCH spatial relation indication including a plurality of time offsets.

FIGS. 5A and 5B are diagrams to illustrate examples of a predicted PUCCH spatial relation indication MAC CE.

FIG. 6 is a diagram to illustrate an example of a predicted SRS spatial relation indication MAC CE.

FIG. 7 is a diagram to illustrate an example of a predicted PDCCH TCI state indication MAC CE.

FIGS. 8A and 8B are diagrams to illustrate examples of a predicted PDSCH TCI state indication MAC CE.

FIGS. 9A and 9B are diagrams to illustrate examples of information about a time for activating a quantized spatial relation/TCI state.

FIGS. 10A and 10B are diagrams to illustrate examples of an available time duration.

FIG. 11 is a diagram to illustrate an example of a schematic structure of a radio communication system according to one embodiment.

FIG. 12 is a diagram to illustrate an example of a structure of a base station according to one embodiment.

FIG. 13 is a diagram to illustrate an example of a structure of a user terminal according to one embodiment.

FIG. 14 is a diagram to illustrate an example of a hardware structure of the base station and the user terminal according to one embodiment.

### DESCRIPTION OF EMBODIMENTS

### (Application of Artificial Intelligence (AI) Technology to Radio Communication)

For future radio communication technologies, it is studied that AI technologies are utilized for control and management of a network/device and the like.

For example, for the future radio communication technologies, especially for communication using a beam, higher accuracy of channel estimation (which may be referred to as channel measurement) is desired for beam management, decoding of a received signal, and the like.

The channel estimation may be performed by using, for example, at least one of a channel state information reference signal (CSI-RS), a synchronization signal (SS), a synchronization signal/broadcast channel (Synchronization Signal/Physical Broadcast Channel (SS/PBCH)) block, a demodulation reference signal (DMRS), a sounding reference signal (SRS), and the like.

For performing high-accuracy channel estimation, radio communication technologies thus far require a large amount of estimation resources (for example, resources for transmitting reference signals), and requires channel estimation for all antenna ports to be used. Increasing resources, such as the DMRS and the CSI-RS, in order to implement the high-accuracy channel estimation reduces resources for data transmission/reception (for example, downlink shared channel (Physical Downlink Shared Channel (PDSCH)) resources and uplink shared channel (Physical Uplink Shared Channel (PUSCH)) resources).

The radio communication technologies thus far can perform control based on a present or past measurement result, but delays handling a disconnected link due to degradation in radio quality, or the like.

For the future, it is studied that high-accuracy channel estimation, future prediction measurement, and the like using less resources are implemented by using AI technologies, such as machine learning (ML). Such channel estimation may be referred to as AI-aided estimation. Beam management using the AI-aided estimation may be referred to as AI-aided beam management.

As an example of the AI-aided beam management, when AI is used in a terminal (also referred to as a user terminal, User Equipment (UE), or the like), the AI may predict a future beam measurement value. The UE may trigger enhanced beam failure recovery (enhanced BFR) with prediction.

As an example of the AI-aided beam management, when AI is used in a base station (BS), the AI may predict a future beam measurement value (for example, a measured value of a narrow beam), or may estimate (derive) a measured value of a narrow beam, based on a small number of beam managements. The UE may receive a beam indication with time offset.

However, studies of concrete details of the AI-aided beam management have not yet been advanced. Unless these are defined appropriately, improvement in communication throughput or communication quality may be suppressed.

Thus, the inventors of the present invention came up with the idea of a control method suitable for a beam indication with time offset, and the like. According to this, a UE can suitably track a beam, and thus it is possible to implement suitable maintenance of communication quality. Note that respective embodiments of the present disclosure may be employed in a case where the AI/prediction is not used.

In one embodiment of the present disclosure, the UE/BS performs training of an ML model in a training mode, and performs the ML model in a test mode (also referred to as a testing mode or the like). In the test mode, validation of accuracy of the ML model trained in the training mode (trained ML model) may be performed.

In the present disclosure, the UE/BS may input, to the ML model, channel state information, a reference signal measurement value, and the like to output high-accuracy channel state information/measured value/beam selection/location, future channel state information/radio link quality, and the like.

Note that in the present disclosure, the AI may be interpreted as an object (also referred to as a target, data, a function, a program, or the like) having (for performing) at least one characteristic of the following:
Estimation based on information to be observed or gathered
Selection based on information to be observed or gathered
Prediction based on information to be observed or gathered

In the present disclosure, the object may be, for example, an apparatus, a device, or the like such as a terminal and a base station. The object may correspond to a program included in the apparatus.

In the present disclosure, the ML model may be interpreted as an object having (for performing) at least one characteristic of the following:
Generating estimated value by feeding information
Predicting estimated value by feeding information
Identifying characteristic by feeding information
Selecting operation by feeding information

In the present disclosure, the ML model may be interpreted as at least one of an AI model, predictive analytics, a predictive analytics model, and the like. The ML model may be derived by using at least one of regression analysis (for example, linear regression analysis, multiple regression analysis, or logistic regression analysis), a support vector machine, a random forest, a neural network, deep learning, and the like. In the present disclosure, the model may be interpreted as at least one of an encoder, a decoder, a tool, and the like.

The ML model outputs, based on input information, at least one piece of information out of an estimated value, a predicted value, selected operation, classification and the like.

The ML model may include supervised learning, unsupervised learning, reinforcement learning, and the like. The supervised learning may be used for learning a general rule for mapping input to output. The unsupervised learning may be used for learning a characteristic of data. The reinforcement learning may be used for learning operation for maximizing an objective (goal).

Respective embodiments mentioned below will be mainly described under assumption of a case where the supervised learning is used for the ML model, but are not limited to this.

In the present disclosure, “perform,” “manage,” “operate,” “execute,” and the like may be interchangeably interpreted. In the present disclosure, a test, after-training, real use, actual use, and the like may be interchangeably interpreted. A signal and a signal/channel may be interchangeably interpreted.

In the present disclosure, the training mode may correspond to a mode in which the UE/BS transmits/receives a signal for the ML model (in other words, an operation mode in a training period). In the present disclosure, the test mode may correspond to a mode in which the UE/BS performs the ML model (for example, performs the trained ML model to predict output) (in other words, an operation mode in a test period).

In the present disclosure, for a specific signal transmitted in the test mode, the training mode may mean a mode in which the specific signal with greater overhead (for example, with a greater amount of resources) is transmitted.

In the present disclosure, the training mode may mean a mode in which a first configuration (for example, a first DMRS configuration or a first CSI-RS configuration) is referred to. In the present disclosure, the test mode may mean a mode in which a second configuration different from the first configuration (for example, a second DMRS configuration or a second CSI-RS configuration) is referred to. At least one of greater numbers of time resources, frequency resources, code resources, and ports (antenna ports) related to measurement may be configured in the first configuration than in the second configuration.

Embodiments according to the present disclosure will be described in detail with reference to the drawings as follows. The radio communication methods according to respective embodiments may each be employed individually, or may be employed in combination.

An ML model related to UE-to-BS communication will be described in the embodiments below, and thus related entities are a UE and a BS, but application of each embodiment of the present disclosure is not limited to this. For example, for communication between other entities (for example, UE-to-UE communication), a UE and a BS of an embodiment described below may be interpreted as a first UE and a second UE. In other words, any of the UE, the BS, and the like of the present disclosure may be interpreted as an arbitrary UE/BS.

In the present disclosure, “A/B” and “at least one of A and B” may be interchangeably interpreted.

In the present disclosure, activate, deactivate, indicate, select, configure, update, determine, and the like may be interchangeably interpreted. In the present disclosure, “support,” “control,” “controllable,” “operate,” and “operable” may be interchangeably interpreted.

In the present disclosure, radio resource control (RRC), an RRC parameter, an RRC message, a higher layer parameter, an information element (IE), and a configuration may be interchangeably interpreted. In the present disclosure, a Medium Access Control control element (MAC Control Element (CE)), an update command, and an activation/deactivation command may be interchangeably interpreted.

In the present disclosure, a panel, a UE panel, a panel group, a beam, a beam group, a precoder, an Uplink (UL) transmission entity, a transmission/reception point (TRP), spatial relation information (SRI), a spatial relation, an SRS resource indicator (SRI), an SRS resource, a control resource set (COntrol REsource SET (CORESET)), a Physical Downlink Shared Channel (PDSCH), a codeword, a base station, a given antenna port (for example, a demodulation reference signal (DMRS) port), a given antenna port group (for example, a DMRS port group), a given group (for example, a code division multiplexing (CDM) group, a given reference signal group, or a CORESET group), a given resource (for example, a given reference signal resource), a given resource set (for example, a given reference signal resource set), a CORESET pool, an uplink control channel (Physical Uplink Control Channel (PUCCH)) group (PUCCH resource group), a spatial relation group, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, an index, an ID, an indicator, and a resource ID may be interchangeably interpreted. In the present disclosure, a sequence, a list, a set, a group, a cluster, a subset, and the like may be interchangeably interpreted.

In the present disclosure, a CSI-RS and at least one of a non-zero power (NZP) CSI-RS, a zero power (ZP) CSI-RS, and CSI interference measurement (CSI-IM) may be interchangeably interpreted.

In the present disclosure, a measured/reported RS may mean an RS measured/reported for predictive BFR.

### (Radio Communication Method)

In embodiments below, a beam indication with time offset may be notified to a UE. The beam indication with time offset may correspond to beam indications corresponding to a plurality of respective times. Hereinafter, the beam indication with time offset, a plurality of beam indications, a beam pattern indication, a predicted beam indication, a sequential beam indication, an enhanced beam indication, and the like may be interchangeably interpreted.

The time offset may mean a time period from a given timing until spatial relation/TCI state activation (until application of the activation).

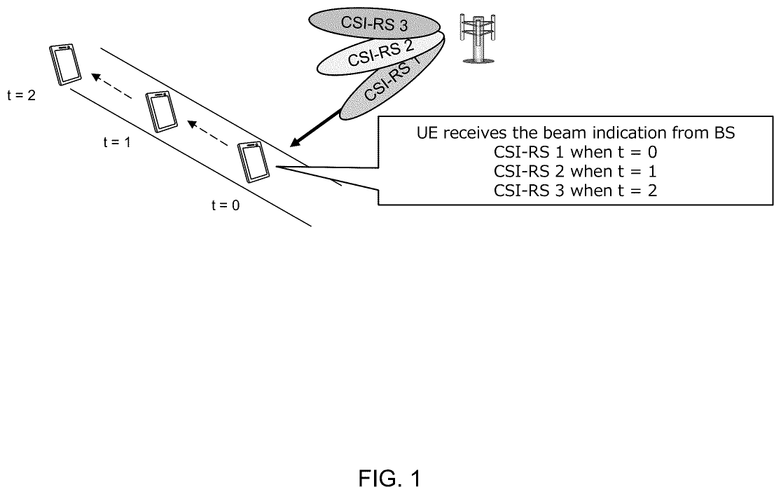

FIG. 1 is a diagram to illustrate an example of the beam pattern indication. In the present example, a BS including AI transmits three CSI-RSs (CSI-RSs 1, 2, and 3), and predicts future beam quality (for example, received quality of each CSI-RS in the UE), based on a signal (for example, an SRS)/beam measurement result (for example, a CSI beam report) from the UE.

The base station may perform, based on the future beam quality, one-shot transmission of the beam pattern indication including information about one or more beams over one or a plurality of times.

The beam pattern indication in FIG. 1 indicates CSI-RS 1 for time t=0 (time offset #0=0 (without time offset)), CSI-RS 2 for time t=1 (time offset #1), and CSI-RS 3 for time t=2 (time offset #3). This may correspond to a beam for which received quality in the UE is predicted to be highest in each time. The UE illustrated moves towards a direction of a dashed line, and the base station generates the above beam pattern indication in consideration of this.

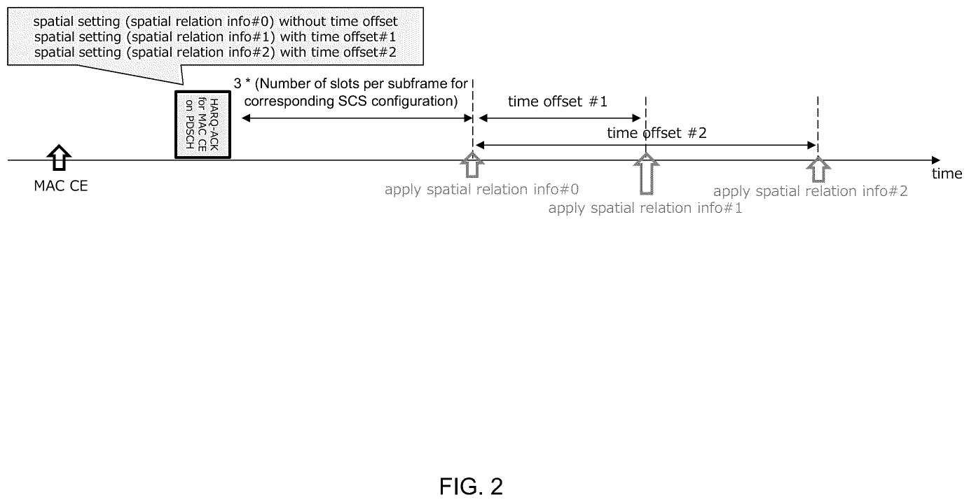

FIG. 2 is a diagram to illustrate an example of control based on the beam pattern indication. The UE may apply (use, assume), in accordance with the received beam pattern indication, a beam for each time instant (time corresponding to each time offset).

In the present example, the UE receives, in a PDSCH, a MAC CE indicating the beam pattern indication, and transmits an ACK (for example, a Hybrid Automatic Repeat reQuest ACKnowledgement (HARQ-ACK)) for this reception. At a timing when a given period (in the diagram, the number 3* of slots per subframe for corresponding subcarrier spacing (SCS) configuration, in other words, 3 ms) has elapsed since this ACK transmission, the UE applies TCI state/spatial relation #0 corresponding to CSI-RS 1. The UE may, after time offset #1 from the above timing, apply TCI state/spatial relation #1 corresponding to CSI-RS 2, and may, after time offset #2 from the above timing, apply TCI state/spatial relation #2 corresponding to CSI-RS 3.

Note that in the present disclosure, the timing, a time, a time period, a slot, a sub-slot, a symbol, a subframe, and the like may be interchangeably interpreted.

The embodiments below relate to details, processing, an application timing, and the like related to a beam pattern indication.

### First Embodiment

A first embodiment relates to a beam pattern indication for a PUCCH. The indication may be referred to as a predicted PUCCH spatial relation activation/deactivation MAC CE, a MAC CE for PUCCH spatial relation activation/deactivation with time offset, a predicted PUCCH spatial relation indication MAC CE, a predicted PUCCH spatial relation indication, or the like.

### Embodiment 1.1

The predicted PUCCH spatial relation indication may include only one time offset. In this case, a UE may apply the predicted PUCCH spatial relation indication (activation command) after either of time periods below has elapsed since a reference timing:
Time offset
Time offset+X* (number of slots per subframe for corresponding SCS configuration)

Here, the reference timing may be (an end of) a timing at which the UE transmits a PUCCH having a HARQ-ACK corresponding to a PDSCH for conveying the activation command, may be (an end of) a timing at which the UE receives a PDSCH for conveying the activation command, or may be a timing obtained by adding X* (the number of slots per subframe for corresponding SCS configuration) to either of these timings.

Note that even in a case where the UE uses, as the reference timing, the timing of the reception of the PDSCH for conveying the activation command, when a first timing after a lapse of the time offset (or time offset+X* (the number of slots per subframe for corresponding SCS configuration)) from the reference timing is earlier than a second timing after a lapse of a given period from the timing of the transmission of the PUCCH having the HARQ-ACK corresponding to the PDSCH for conveying the above activation command, as compared to the above second timing, the UE may apply the above activation command at the above second timing. This case can suppress a change in a spatial relation of the PUCCH before the above PUCCH transmission. Note that this given period may be X* (the number of slots per subframe for corresponding SCS configuration), may be a time offset, or may be time offset+X* (the number of slots per subframe for corresponding SCS configuration).

Note that the UE may determine the above X value, based on a specific rule, based on physical layer signaling (for example, DCI), higher layer signaling (for example, RRC signaling or a MAC CE), a specific signal/channel, or combinations of these, or based on a UE capability. X may be, for example, 3.

Note that the UE may apply the activation command in a specific slot (for example, the first slot or the first UL slot) after either of the above time periods has elapsed since the reference timing.

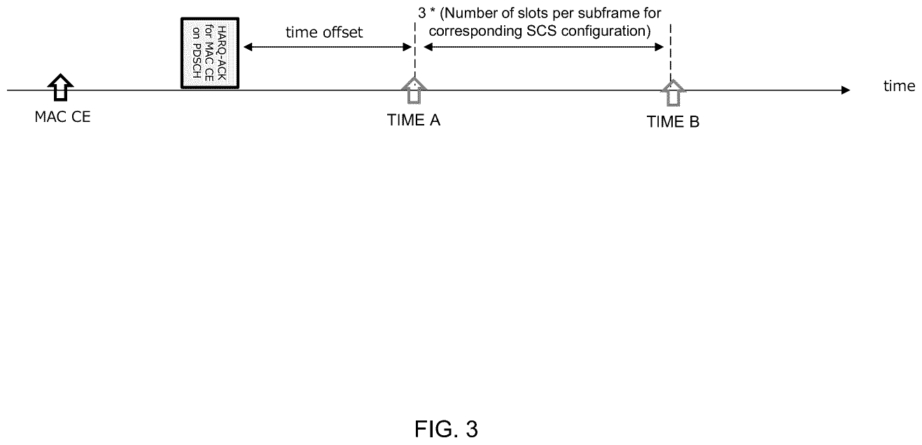

FIG. 3 is a diagram to illustrate an example of an application timing of the predicted PUCCH spatial relation indication including one time offset. In the present example, the above reference timing is a timing at which the UE transmits a HARQ-ACK corresponding to the activation command.

Time A illustrated is a time for application of the activation command in a case where the application is performed after the time offset has elapsed since the reference timing. Time B illustrated is a time for application of the activation command in a case where the application is performed after the time offset+3* (the number of slots per subframe for corresponding SCS configuration) has elapsed since the reference timing.

### Embodiment 1.2

The predicted PUCCH spatial relation indication may include a plurality of time offsets. The predicted PUCCH spatial relation indication may include spatial configurations (spatial relation information) corresponding to the respective time offsets.

Note that the time offset may be an absolute time offset. In this case, spatial relation information corresponding to a given time offset may be applied after the time offset has elapsed since the above reference timing. The reference timing corresponds to time offset=0.

The time offset may be a relative (differential) time offset. In this case, the spatial relation information corresponding to the given time offset may be applied after the time offset has elapsed since a closer one (more recent one) of the above reference timing and a timing at which spatial relation information corresponding to another time offset is applied (the activation command is applied last). In other words, the spatial relation information corresponding to the given time offset may be applied after the sum of the time offset and another time offset has elapsed since the above reference timing.

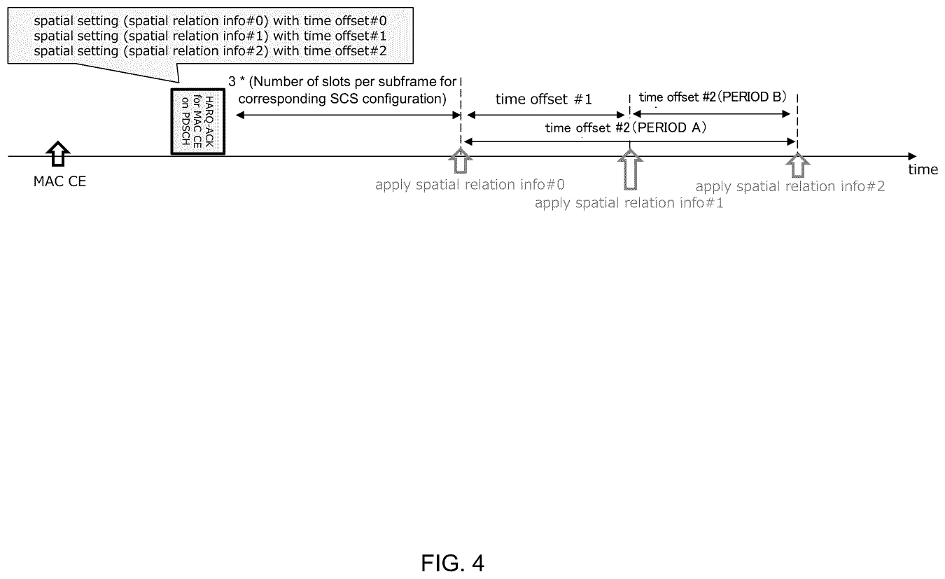

FIG. 4 is a diagram to illustrate an example of an application timing of the predicted PUCCH spatial relation indication including the plurality of time offsets. The present example is similar to FIG. 2, but time offset #2 is a length of period A illustrated when the time offset is an absolute time offset, and time offset #2 is a length of period B illustrated when the time offset is a relative time offset.

### Embodiment 1.3

The UE may determine a time offset, based on a specific rule, based on physical layer signaling (for example, DCI), higher layer signaling (for example, RRC signaling or a MAC CE), a specific signal/channel, or combinations of these, or based on a UE capability.

For example, the UE may be configured with the time offset by an RRC parameter for each piece of spatial relation information/for each PUCCH resource. The UE may assume that a time offset is not applied (or time offset=0 is applied) to spatial relation information/PUCCH resource without a configured time offset, or may apply a default time offset to the spatial relation information/PUCCH resource.

The default time offset may be determined based on a specific rule, may correspond to a specific time offset of configured time offsets, or may be determined based on a UE capability.

Embodiment 1.3 in which a time offset is configured for each piece of spatial relation information/PUCCH resource is suitable for a case where the UE moves on a determined route (for example, when riding a train).

### Embodiment 1.4

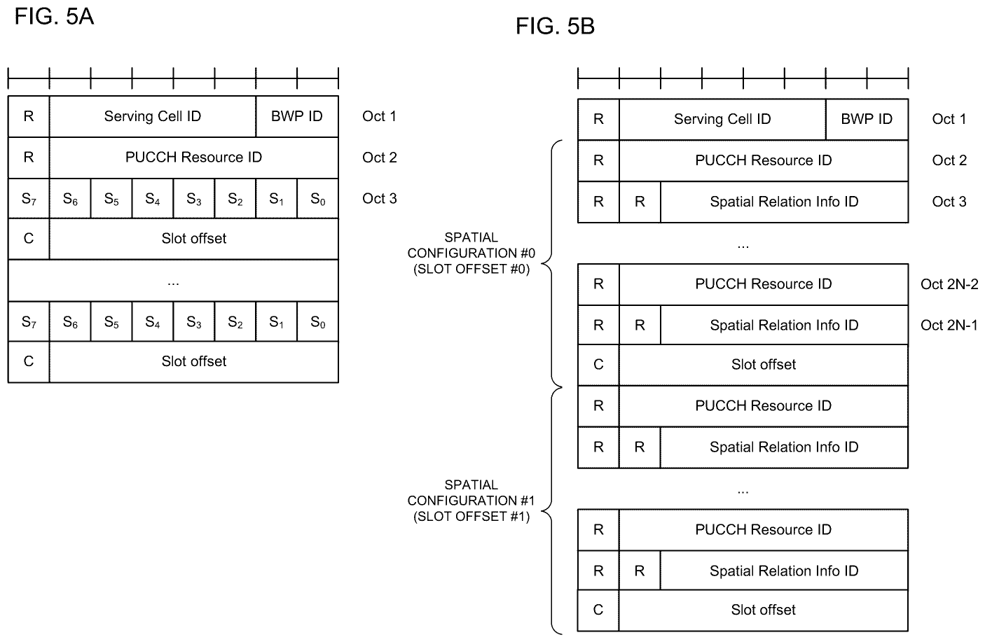

FIGS. 5A and 5B are diagrams to illustrate examples of the predicted PUCCH spatial relation indication MAC CE. The MAC CE may include a serving cell ID field, a BWP ID field, a PUCCH resource ID field, a spatial relation ID (or Sᵢ) field, a C field, a slot offset field, and the like.

The serving cell ID field may be a field for indicating a serving cell to which the MAC CE is applied. The BWP ID field may be a field for indicating a UL BWP to which the MAC CE is applied.

The PUCCH resource ID field may indicate an ID (Identifier) of a PUCCH resource for which a spatial relation is activated by spatial relation information.

The spatial relation ID field indicates a spatial relation ID of a spatial relation to be activated (for example, PUCCH-SpatialRelationInfoId). The Sᵢ field indicates a spatial relation to be activated/deactivated, and corresponds to a spatial relation with spatial relation ID (PUCCH-SpatialRelationInfoId) i (or i+1). For example, the Sᵢ field may, if being 1, indicate the activation.

The slot offset field may indicate a time offset for activating a spatial relation.

The C field may indicate whether a spatial relation ID (or Sᵢ) field (or another spatial configuration) is present after this C field. For example, the C field may, if a value of the C field is 1, indicate that an octet including a spatial relation ID (or Sᵢ) field is present after this C field, and may, if the value of the C field is 0, mean that an octet including a spatial relation ID (or Sᵢ) field is absent after this C field.

FIG. 5A illustrates an example in which one or more combinations of a slot offset field and a corresponding Sᵢ field are included for the PUCCH resource indicated by the PUCCH resource ID field.

FIG. 5B illustrates an example in which one or more combinations of a PUCCH resource ID field and a corresponding spatial relation ID field are included for one slot offset field. In this case, at a timing of a time offset indicated by the slot offset field, different spatial relations can be activated for a plurality of PUCCH resources. Spatial configuration #0 and spatial configuration #1 illustrated may correspond to different time offsets (spatial configuration #0 and spatial configuration #1 may correspond to slot offset #0 indicated by a first slot offset field and slot offset #1 indicated by a second slot offset field, respectively). The spatial configuration may correspond to configuration for correspondence between a PUCCH resource and a spatial relation, the correspondence corresponding to one slot offset.

The predicted PUCCH spatial relation indication MAC CE may include a field indicating a cell to which the spatial relation information belongs. For example, when the spatial relation information is configured for each cell, the above MAC CE may include a field for determining such a cell ID as a physical cell ID (PCI). The PCI may be selected from PCI candidates configured by RRC.

The predicted PUCCH spatial relation indication MAC CE may include a field indicating how many time instants (time offsets) are present in the MAC CE, a field indicating whether a specific octet is present, and the like.

The UE may judge that a size of the predicted PUCCH spatial relation indication MAC CE is fixed (predetermined), may judge the size, based on an RRC parameter, or may judge the size, based on a field of the MAC CE.

The above RRC parameter may be at least one of a maximum number of pieces of spatial relation information, a maximum number of PUCCH resources, the number of time instants in the MAC CE, and the like.

The above field of the MAC CE may correspond to at least one of the following:
Information indicating whether given octet is present in this MAC CE (for example, the above-mentioned C field)
Number indicated by given field (for example, a field indicating the number of spatial configurations included in the MAC CE)

According to the first embodiment described above, it is possible to appropriately perform beam pattern indication using a predicted PUCCH spatial relation indication.

### Second Embodiment

A second embodiment relates to a beam pattern indication for an SRS. The indication may be referred to as a predicted enhanced SP/AP SRS spatial relation indication MAC CE, a MAC CE for SP/AP SRS spatial relation indication with time offset, a predicted SRS spatial relation indication MAC CE, a predicted SRS spatial relation indication, or the like. Note that SP/AP is the meaning of semi-persistent/aperiodic.

As the second embodiment, an embodiment obtained by interpreting, in Embodiments 1.1 to 1.4, the PUCCH as an SRS can be used, and thus overlapped description will not be repeated.

Note that a Resource IDᵢ field corresponds to a field for specifying a spatial relation. The Resource IDᵢ field may indicate an ID (for example, an SSB index or an SRS resource ID) of a resource used for deriving a spatial relation for the i−1 (or i) th SRS resource in an SRS resource set indicated by an SRS resource set ID field.

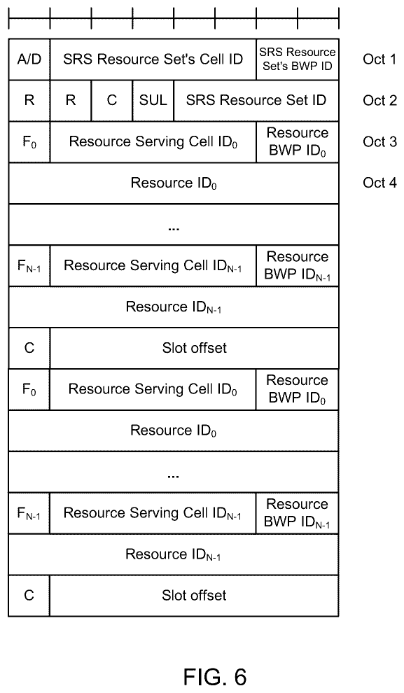

FIG. 6 is a diagram to illustrate an example of the predicted SRS spatial relation indication MAC CE. The MAC CE is similar to an enhanced SP/AP SRS spatial relation indication MAC CE in Rel. 16, except for C fields and slot offset fields, and thus description of respective fields will be omitted. In a manner similar to that illustrated in FIGS. 5A and 5B, a spatial relation corresponding to an SRS resource for each slot offset can be specified.

According to the second embodiment described above, it is possible to appropriately perform beam pattern indication using a predicted SRS spatial relation indication.

### Third Embodiment

A third embodiment relates to a beam pattern indication for a downlink control channel (Physical Downlink Control Channel (PDCCH)). The indication may be referred to as a predicted UE-specific PDCCH TCI state indication MAC CE (Predicted TCI State Indication for UE-specific PDCCH MAC CE), a MAC CE for PDCCH TCI state indication with time offset, a predicted PDCCH TCI state indication MAC CE, a predicted PDCCH TCI state indication, or the like.

As the third embodiment, an embodiment obtained by interpreting, in Embodiments 1.1 to 1.4, the PUCCH, PUCCH resource, spatial relation, and the like as a PDCCH, CORESET (or CORESET ID), TCI state applicable to a CORESET, and the like, respectively, can be used, and thus overlapped description will not be repeated.

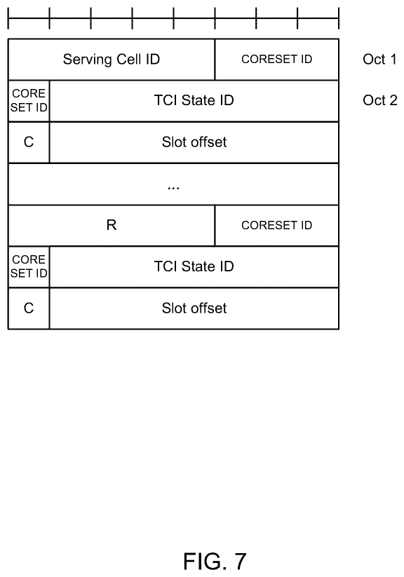

FIG. 7 is a diagram to illustrate an example of the predicted PDCCH TCI state indication MAC CE. The MAC CE is similar to a UE-specific PDCCH TCI state indication MAC CE in Rel. 15/16, except for C fields and slot offset fields, and thus description of respective fields will be omitted. In a manner similar to that illustrated in FIGS. 5A and 5B, a TCI state corresponding to a CORESET (CORESET ID) for each slot offset can be specified.

According to the third embodiment described above, it is possible to appropriately perform beam pattern indication using a predicted PDCCH TCI state indication.

### Fourth Embodiment

A fourth embodiment relates to a beam pattern indication for a PDSCH. The indication may be referred to as a predicted (enhanced) UE-specific PDSCH TCI state activation/deactivation MAC CE (Predicted (Enhanced) TCI States Activation/Deactivation for UE-specific PDSCH MAC CE), a MAC CE for PDSCH TCI state indication with time offset, a predicted PDSCH TCI state indication MAC CE, a predicted PDSCH TCI state indication, or the like.

As the fourth embodiment, an embodiment obtained by interpreting, in Embodiments 1.1 to 1.4, the PUCCH, spatial relation, and the like as a PDSCH, TCI state, and the like, respectively, can be used, and thus overlapped description will not be repeated.

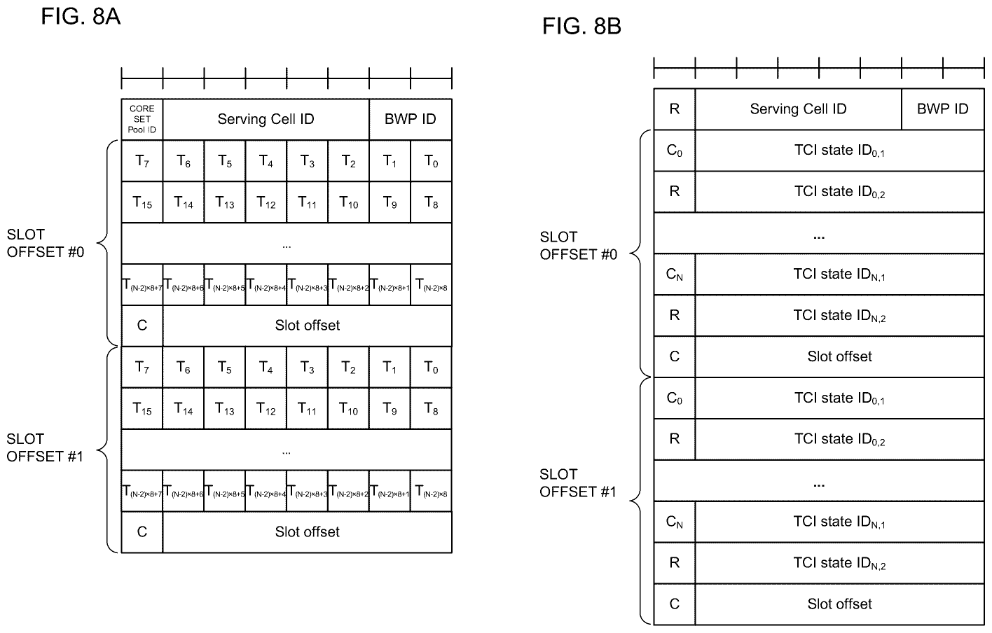

FIGS. 8A and 8B are diagrams to illustrate examples of the predicted PDSCH TCI state indication MAC CE. The MAC CE is similar to a UE-specific PDSCH TCI state activation/deactivation MAC CE and an enhanced UE-specific PDSCH TCI state activation/deactivation MAC CE in Rel. 15/16, except for C fields and slot offset fields, and thus description of respective fields will be omitted. In a manner similar to that illustrated in FIGS. 5A and 5B, a TCI state for a PDSCH for each slot offset can be specified.

According to the fourth embodiment described above, it is possible to appropriately perform beam pattern indication using a predicted PDSCH TCI state indication.

### Fifth Embodiment

A fifth embodiment relates to time offsets specified by the MAC CEs of the first to fourth embodiments.

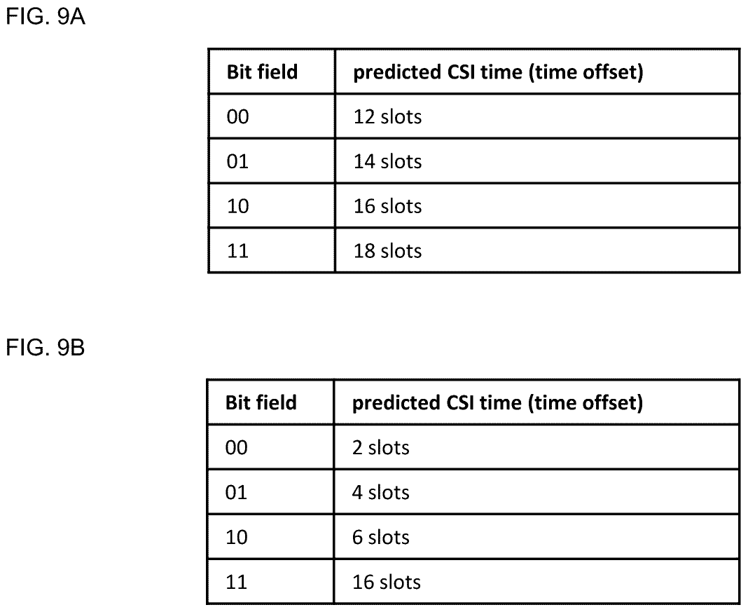

FIGS. 9A and 9B are diagrams to illustrate examples of information about a time for activating a quantized spatial relation/TCI state.

A UE may be notified, by the MAC CE, of a bit field (time offset field) indicating one time offset selected from configured time offsets. In FIG. 9A, the UE assumes that four time offsets (12, 14, 16, and 18 slots) corresponding to respective bit fields are configured by using an RRC parameter.

Note that the UE may not, when being configured with only one time offset, receive the information about a time for activating the spatial relation/TCI state (because a base station recognizes the time offset assumed by the UE).

The UE may receive, as the information about a time for activating the spatial relation/TCI state, a bit field indicating one time offset selected from predefined time offsets. In FIG. 9B, four time offsets (2, 4, 6, and 8 slots) corresponding to respective bit fields may be predefined by, for example, a specification.

Note that when the UE handles a time offset, the UE may determine, based on the time offset, a time duration available for prediction. One or more times for activating the spatial relation/TCI state may present within the time duration.

In the present disclosure, in order to determine the time duration, the UE may report/receive/determine/be configured with a time offset and a window size, in place of the time offset.

The UE may activate the spatial relation/TCI state in a specific time instant (for example, a specific slot) within the time duration specified by the time offset and the window size.

In the present disclosure, in order to determine the time duration, the UE may report/receive/determine/be configured with two time offsets, in place of one time offset.

The UE may activate the spatial relation/TCI state in a specific time instant (for example, a specific slot) within the time duration specified by the two time offsets.

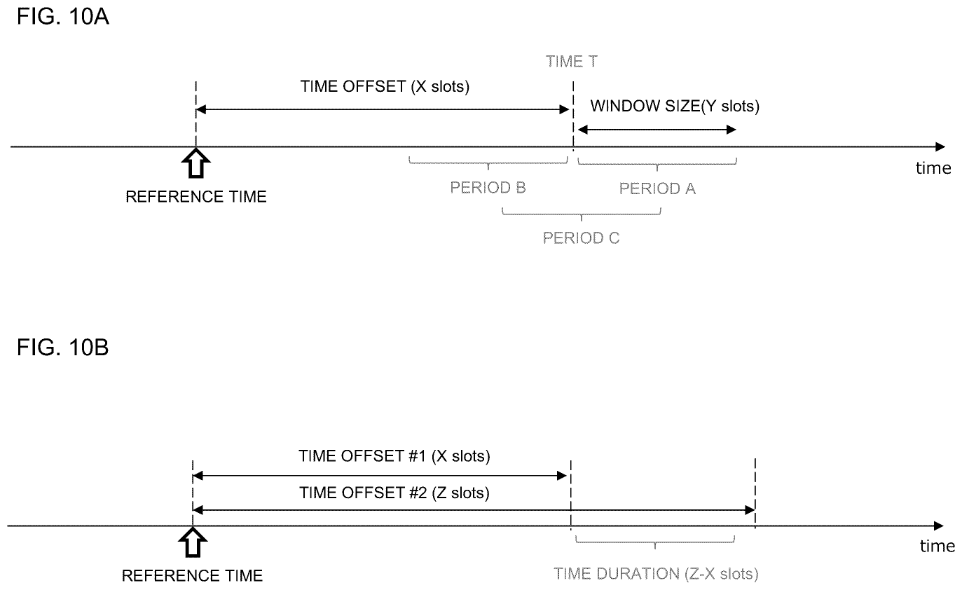

FIGS. 10A and 10B are diagrams to illustrate examples of the available time duration.

FIG. 10A illustrates an example in which the time duration is specified by a time offset and a window size. The time duration may be at least one of periods A to C illustrated. Period A is a period using, as a start time, a point (time T) identified by the time offset from a reference time (period after the point), the period having a window size width. Period B is a period using, as an end time, the point (time T) identified by the time offset from the reference time (period before the point), the period having the window size width. Period C is a period using, as the center of the window size width, the point (time T) identified by the time offset from the reference time (including periods before and after the point), the period having the window size width.

FIG. 10B illustrates an example in which the time duration is specified by two time offsets (first time offset and second time offset). The time duration may be a period illustrated. This period is a period using, as a start time, one of a point identified by the first time offset from a reference time and a point identified by the second time offset from the reference time, the period using the other as an end time. Assuming that, for example, the second time offset (for example, Z slots)>the first time offset (for example, X slots), a length of this period may be represented as Z-X.

According to the fifth embodiment described above, it is possible to appropriately specify a time offset.

### <Others>

At least one of the above-mentioned embodiments may be employed in only a UE that has reported a specific UE capability or that supports the specific UE capability.

The specific UE capability may indicate at least one of the following:
Whether to support specific operation/information in each embodiment
Maximum number of time instants included in one MAC CE (for each MAC CE type)
Maximum time offset for spatial relation
Maximum time offset for TCI state for PDSCH
Maximum time offset for TCI state for PDCCH (for each CORESET/for each CORESET pool/for all CORESETs (pools))

The above UE capability may be reported for each frequency, may be reported for each frequency range (for example, Frequency Range 1 (FR1), Frequency Range 2 (FR2), FR2-1, or FR2-2), may be reported for each cell, may be reported for each UE, or may be reported for each subcarrier spacing (SCS).

The above UE capability may be reported in common for time division duplex (TDD) and frequency division duplex (FDD), or may be reported independently of each other.

At least one of the above-mentioned embodiments may be employed in a case where a UE is configured with specific information related to the above-mentioned embodiments by using higher layer signaling. For example, the specific information may be information indicating enabling of beam pattern indication, an arbitrary RRC parameter for specific release (for example, Rel. 18), or the like.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

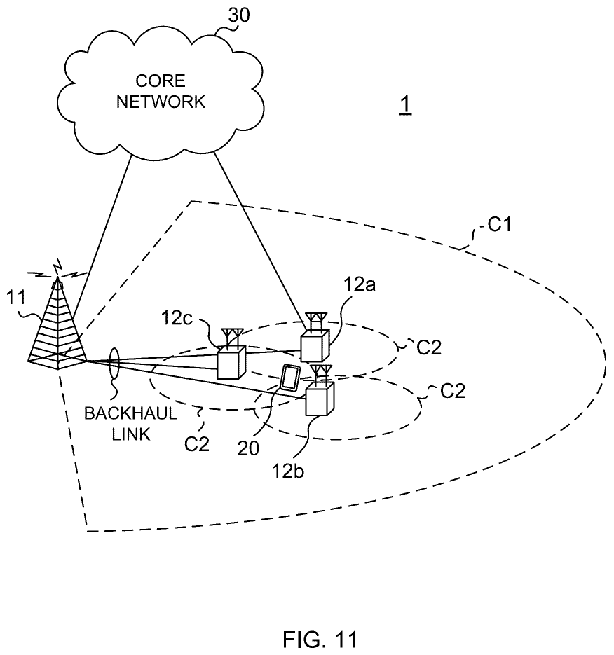

FIG. 11 is a diagram to illustrate an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect illustrated in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

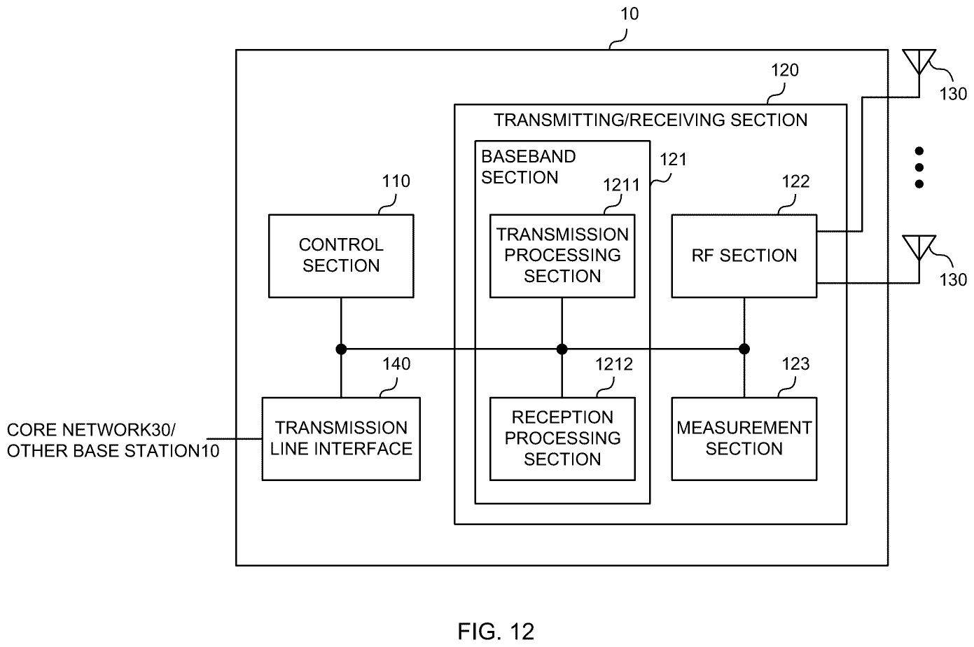

FIG. 12 is a diagram to illustrate an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily illustrates functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit, to the user terminal 20, a Medium Access Control control element (MAC Control Element (CE)) including a field indicating a time period from a given timing (reference timing) until activation of a spatial relation.

The control section 110 may assume that the user terminal 20 controls, based on the MAC CE, the activation of the spatial relation, and may perform, based on the assumption, control of scheduling/beam.

The transmitting/receiving section 120 may transmit, to the user terminal 20, a Medium Access Control control element (MAC Control Element (CE)) including a field indicating a time period from a given timing (reference timing) until activation of a transmission configuration indication state (TCI state).

The control section 110 may assume that the user terminal 20 controls, based on the MAC CE, the activation of the TCI state, and may perform, based on the assumption, control of scheduling/beam.

### (User Terminal)

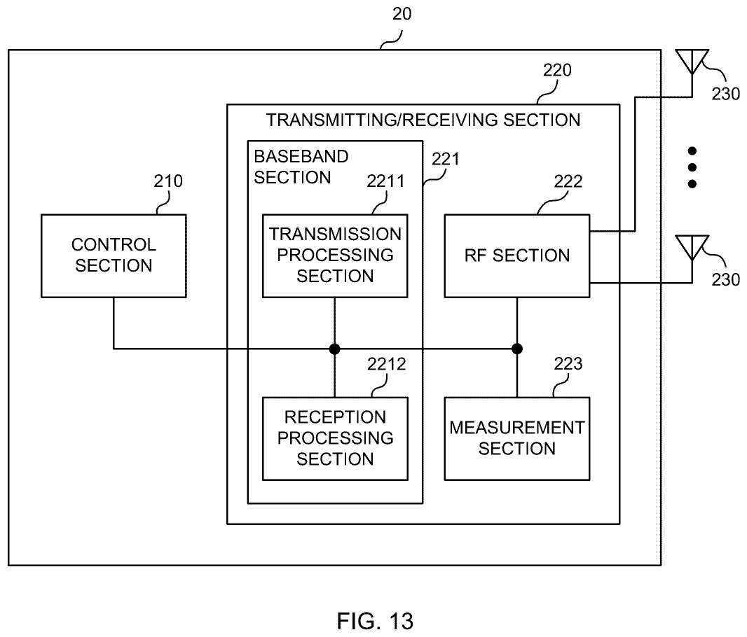

FIG. 13 is a diagram to illustrate an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily illustrates functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220, the transmitting/receiving antennas 230, and the communication path interface 240.

Note that the transmitting/receiving section 220 may receive a Medium Access Control control element (MAC Control Element (CE)) including a field indicating a time period from a given timing (reference timing) until activation of a spatial relation.

The control section 210 may control the activation of the spatial relation, based on the MAC CE.

The given timing may be a timing at which an uplink control channel having a Hybrid Automatic Repeat reQuest ACKnowledgement (HARQ-ACK) corresponding to a downlink shared channel for conveying the MAC CE is transmitted.

The transmitting/receiving section 220 may receive a Medium Access Control control element (MAC Control Element (CE)) including a field indicating a time period from a given timing (reference timing) until activation of a transmission configuration indication state (TCI state).

The control section 210 may control the activation of the TCI state, based on the MAC CE.

When the above-mentioned MAC CE includes the field indicating a first time period and the field indicating a second time period, the control section 210 may activate a first spatial relation/TCI state after the first time period has elapsed since the given timing, and may activate a second spatial relation/TCI state after the second time period has elapsed since the given timing. This may correspond to a case where the field indicates an absolute time period.

When the above-mentioned MAC CE includes the field indicating a first time period and the field indicating a second time period, the control section 210 may activate a first spatial relation/TCI state after the first time period has elapsed since the given timing, and may activate a second spatial relation/TCI state after the sum of the first time period and the second time period has elapsed since the given timing. This may correspond to a case where the field indicates an absolute time period.

### (Hardware Structure)

Note that the block diagrams that have been used to describe the above embodiments illustrate blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

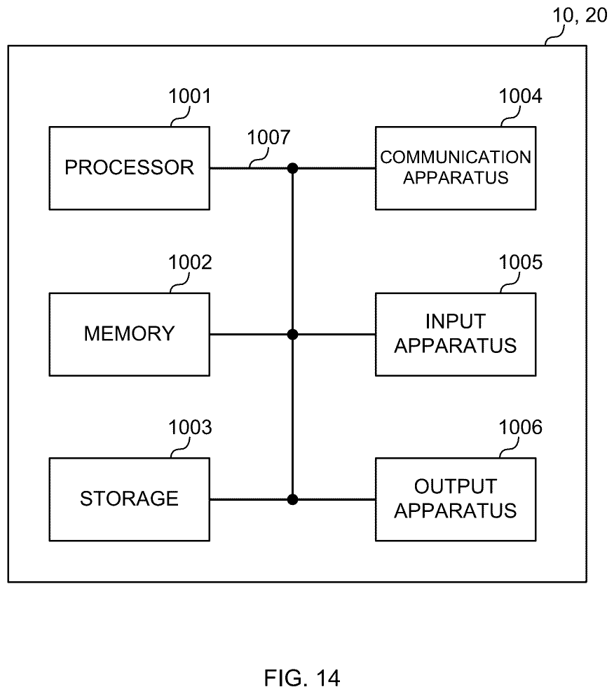

For example, a base station, a user terminal, and so on according to one embodiment of the present disclosure may function as a computer that executes the processes of the radio communication method of the present disclosure. FIG. 14 is a diagram to illustrate an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses illustrated in the drawings, or may be configured not to include part of apparatuses.

For example, although only one processor 1001 is illustrated, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAN), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives a Medium Access Control control element (MAC Control Element (CE)) including a field indicating a time period from a given timing until activation of a transmission configuration indication state (TCI state); and
a control section that controls the activation of the TCI state based on the MAC CE.

2. The terminal according to claim 1, wherein
when the MAC CE includes the field indicating a first time period and the field indicating a second time period, the control section activates a first TCI state after the first time period has elapsed since the given timing, and activates a second TCI state after the second time period has elapsed since the given timing.

3. The terminal according to claim 1, wherein
when the MAC CE includes the field indicating a first time period and the field indicating a second time period, the control section activates a first TCI state after the first time period has elapsed since the given timing, and activates a second TCI state after a sum of the first time period and the second time period has elapsed since the given timing.

4. The terminal according to claim 1, wherein
the given timing is a timing at which an uplink control channel having a Hybrid Automatic Repeat reQuest ACKnowledgement (HARQ-ACK) corresponding to a downlink shared channel for conveying the MAC CE is transmitted.

5. A radio communication method for a terminal, the radio communication method comprising:
receiving a Medium Access Control control element (MAC Control Element (CE)) including a field indicating a time period from a given timing until activation of a transmission configuration indication state (TCI state); and
controlling the activation of the TCI state based on the MAC CE.

6. A base station comprising:
a transmitting section that transmits, to a terminal, a Medium Access Control control element (MAC Control Element (CE)) including a field indicating a time period from a given timing until activation of a transmission configuration indication state (TCI state); and
a control section that assumes that the terminal controls, based on the MAC CE, the activation of the TCI state.

7. The terminal according to claim 2, wherein
the given timing is a timing at which an uplink control channel having a Hybrid Automatic Repeat reQuest ACKnowledgement (HARQ-ACK) corresponding to a downlink shared channel for conveying the MAC CE is transmitted.

8. The terminal according to claim 3, wherein
the given timing is a timing at which an uplink control channel having a Hybrid Automatic Repeat reQuest ACKnowledgement (HARQ-ACK) corresponding to a downlink shared channel for conveying the MAC CE is transmitted.
